(19) United States
(12) Patent Application Publication
(10) Pub. No.: US 2004/0107213 A1
(43) Pub. Date: Jun. 3, 2004

(54) Systems and methods for generating data files for testing EDI receiving and processing capabilities

(76) Inventors: Pedro Zubeldia, Kaysville, UT (US); Randy Tate, Draper, UT (US); Travis Stockwell, Riverton, UT (US); Jeff Compas, Lehi, UT (US)

Correspondence Address: TRASK BRITT, P.O. BOX 2550, SALT LAKE CITY, UT, 84110, US

(21) Appl. No.: 10/308,911

(22) Filed: Dec. 2, 2002

(51) Int. Cl. G06F 17/00

(52) U.S. Cl. 707/104.1

(57) ABSTRACT

Systems and methods for generating data files for testing computer systems. A base EDI file it provided to a file generating system, preferably by way of a network connection. The file generating system generates a test file by varying at least one parameter of at least one data field contained in the base file, in accordance with a set of instructions. The test file may be saved as part of a test file suite assembled from a number of test files generated by the file generating system. The test file may then be used to test the ability of an EDI system to receive, process or transmit an EDI data file containing the modified data field.

### FIELD OF THE INVENTION

The present invention is directed to creating data files designed for use in determining the capabilities of a system to process, transmit or receive electronic data. One embodiment of the present invention provides methods and systems for creating test files for examining the parameters of a system to process, send or receive EDI files. This may be accomplished by using a test file generation system which may be accessible over a network connection with an parameter database stored in a memory thereon to carry out the methods described herein.

### BACKGROUND OF THE INVENTION

It has become increasingly common for business entities to exchange data in electronic form. The use of email and the internet to communicate has allowed commerce to proceed at a much faster pace and for cost savings to be realized from the speed involved and the smaller number of people needed to pass communications. Specialized data communication between trading partners, such as a manufacturing company and its suppliers, typically requires the set up and maintenance of a separate proprietary system. Setting up these proprietary systems has enabled cost savings to be realized, but requires the trading partners to spend time testing, debugging and converting their systems at each end. The debugging process may be further complicated as occurrence of an error may require systems to be modified on each end. Where an entity has a number of trading partners, such as a distributor receiving orders from a number of retailers, this process has to be repeated for each trading partner added top the system.

There have been attempts to standardize the interchange of electronic data, such as the American National Standards Institute (ANSI) Accredited Standards Committee (ASC) X12 that develops uniform standards for interindustry electronic interchange of business transactions—electronic data interchange (EDI). While the adoption of common standards has simplified the process of selecting and implementing EDI systems, the debugging process still requires a large investment of time and debugging on each side.

While some health care providers currently use EDI transactions to achieve cost savings in transactions, there is no currently completely implemented standard format. Currently about 400 different EDI formats are being used in the health care area. The Health Insurance Portability and Accountability Act (HIPAA), enacted in 1996 requires U.S. based health care providers, claims processors and payers to transmit claims and other transactions using a set of common EDI standards. These national standards were proposed in Federal Register Vol. 63, No. 88 page 252272, et seq. Health Insurance Reform: Standards for Electronic Transactions and adopted in 45 CFR Parts 160 and 162, as published in the Federal Register Vol. 65 No. 160 Pg 50312 to 50372, Health Insurance Reform: Standards for Electronic Transactions each of which is incorporated in its entirety herein. Addenda and clarifications to these rules are contained in Federal Register Vol. 65, No. 160 Page 50373 Health Insurance Reform: Announcement of Designated Maintenance Standards Organizations and Federal Register Vol. 65, No. 227, Healthcare Integrity and Protection Data Bank for Final Adverse Information on Health Care Providers, Suppliers and Practitioners, each of which is incorporated by reference in its entirety herein. A number of X12 Implementation guides have been developed and are available from the ASC X12 committee, setting and detailing the specific standards for the different aspects of the medical industry and the implementation of their adoption by all health care providers. These implementation guides include National Electronic Data Interchange Transaction Set Implementation Guide, Health Care claim Request for Additional Information 277; National Electronic Data Interchange Transaction Set Implementation Guide, Health Care Data Element Dictionary, May 2000; Logical Observation Identifier Names and Codes (LOINC®) Committee, LOINC® Modifier Codes For use with ASC X12N 277 Implementation Guides when Requesting Additional Information, NPRM Draft Dec. 10, 2001; National Electronic Data Interchange Transaction Set Implementation Guide, Payroll Deducted and Other Group Premium Payment for Insurance Products 820, ASC X12N 820 (004010X061), May 2000; National Electronic Data Interchange Transaction Set Implementation Guide, Payroll Deducted and Other Group Premium Payment For Insurance Products 820 ADDENDA, ASC X12N 820 (004010X061A1); National Electronic Data Interchange Transaction Set Implementation Guide, Health Care claim Payment/Advice 835, ASC X12N 835 (004010X091), May 2000; National Electronic Data Interchange Transaction Set Implementation Guide, Health Care claim Payment/Advice 835 ADDENDA, ASC X12N 835 (004010X091A1); National Electronic Data Interchange Transaction Set Implementation Guide, Health Care Eligibility Benefit Inquiry and Response 270/271, ASC X12N 270/271 (004010X092), May 2000; National Electronic Data Interchange Transaction Set Implementation Guide, Health Care Eligibility Benefit Inquiry and Response 270/271 ADDENDA, ASC X12N 270/271 (004010X092A1), October 2001 NPRM Draft; National Electronic Data Interchange Transaction Set Implementation Guide, Health Care claim Status Request and Response 276/277, ASC X12N 276/277 (004010X093); National Electronic Data Interchange Transaction Set Implementation Guide, Health Care claim Status Request and Response 276/277 ADDENDA, ASC X12N 276/277 (004010X093A1); National Electronic Data Interchange Transaction Set Implementation Guide, Health Care Services Review—Request for Review and Response 278 ASC X12N 278 (004010X094), May 2000; National Electronic Data Interchange Transaction Set Implementation Guide, Health Care Services Review—Request for Review and Response 278 ADDENDA, ASC X12N 278 (004010X094A1); National Electronic Data Interchange Transaction Set Implementation Guide, Benefit Enrollment and Maintenance 834, ASC X12N 834 (004010X095), May 2000; National Electronic Data Interchange Transaction Set Implementation Guide, Benefit Enrollment and Maintenance 834 ADDENDA, ASC X12N 834 (004010X095A1); National Electronic Data Interchange Transaction Set Implementation Guide, Health Care claim: Institutional, 837, ASC X12N 837 (004010X096), May 2000; National Electronic Data Interchange Transaction Set Implementation Guide, Health Care claim: Institutional, 837 ADDENDA, ASC X12N 837 (004010X096A1); National Electronic Data Interchange Transaction Set Implementation Guide, Health Care claim: Dental, 837 ASC X12N 837 (004010X097), May 2000; National Electronic Data Interchange Transaction Set Implementation Guide, Health Care claim: Dental, 837 ADDENDA, ASC X12N 837 (004010X097A1); National Electronic Data Interchange Transaction Set Implementation Guide, Health Care claim: Professional, 837 ASC X12N 837 (004010X098), May 2000; National Electronic Data Interchange Transaction Set Implementation Guide, Health Care claim: Professional, 837 ADDENDA, ASC X12N 837 (004010X098A1); NCPDP Telecommunication Standard Format, Version 5.1 and the NCPDP Batch Standard, Version 1 Release 0; each of which is incorporated herein by reference in its entirety.

It is estimated that with the adoption of universal standards for healthcare EDI, the costs of each transaction will drop significantly once the changeover has been made by all healthcare providers. Adoption of similar standards in other fields is should have a similar cost savings effect.

The traditional method of setting up an EDI transaction system is to set a system up and convey test messages back and forth between partners troubleshooting at each end until system successfully works. Personnel are required at each end and disputes as to which system is experiencing errors are common. Where there are multiple trading partners, changes made to a system in response to problems with one trading partner may result in problems occurring in transactions with other trading partners. Co-pending U.S. patent application Ser. No. 10/062,980, filed Jan. 31, 2002 and entitled Systems and Methods Relating to the Establishment of EDI Trading Partners Relationships, the entire disclosure of which is hereby incorporated by reference herein, details novel approaches to simplifying such debugging. As with traditional debugging, a user must successfully create, transmit and receive EDI files for certification.

An X12 compliant EDI data file may comprise or include or be represented as a string of segments, each segments including one or more data elements. Each segment may thus be thought of as containing one or more data fields, each data field containing a piece of information for the EDI transaction. These segments may be organized into one or more “data loops” each of which may contain unique data. Each data loop can be identified by a unique control number contained therein that can be used to identify the transaction represented by that loop. A single X12 file may report anywhere from a single transaction to 10,000 or more transactions, each of which can be identified by unique control numbers contained in those data loops. The characteristics of each data field (which may comprise a data loop or be contained in a data loop, depending on the specific data at issue) may vary from message to message. For example, for EDI data files for transmission of data concerning medical services provided to a patient, one data field will represent the patient's last name. The size of this data field will vary from patient to patient, as the last name varies, including number of characters. Similar variation will occur for each data field. In order to successfully debug and/or certify an EDI trading partner for conveying and receiving messages, the ability of a user to send and receive EDI files containing all necessary variations for each data field that will be used in transactions needs to be established. This requires the transmission of a large number of EDI files.

Many EDI transmissions contain information that must be, or is preferred to be, maintained in confidence. For example, patient data associated with medically related EDI transmission must be kept confidential. Similarly, EDI trading partners, such as a manufacturer and distributor may wish to maintain customer information, customer lists, amounts ordered, or other information in confidence. Maintaining data in confidence may hamper attempts to set up and debug systems, as it limits data available for testing and can preclude testing under actual use conditions. In order to address this problem, it is possible to use test files, that contain mock data to test the parameters of a system. Creating test files to test every required parameter of an EDI file for use in certain types of transactions may involve hundreds or thousands of files. The creation of such large numbers of test files containing mock data may be time consuming and difficult.

The use of mock data files to protect the confidentiality of data can then create further problems. For example, an EDI trading partner uses multiple computer systems for receiving and processing EDI data files, or a single integrated system with a receiving “front end” and a processing “back end.” Such systems may refuse to accept, or be incapable of attempting to process EDI files that do not identify a recognized trading partner. While such a system could be tested by the creation of a mock trading partner for the limited purposes of testing, it may be necessary or required to use files that identify actual trading partners in order to ensure that test results are indicative of actual use, or to acquire necessary certification.

Currently, there are systems and processes available for creating data test files for specific purposes. However, none of these are directed to data files that are suitable for X12 EDI transmissions. Such systems test software or hardware by randomly selecting instructions from a database, which are then provided for the hardware or software to perform as a randomly generated test file.

A system and methods able to create a test file for use in examining an EDI transaction would be desirable. Such a system or process able to generate an entire suite of test files from a single starting file would be further desirable, as would a system able to generate a suite of test files specifically designed to test selected parameters of an EDI receiving or processing computer system.

### SUMMARY OF THE INVENTION

The present invention is directed to systems and methods for generating data files for testing computer systems. A base EDI file it provided to a file generating system, preferably by way of a network connection. The file generating system generates a test file by varying at least one parameter of at least one data field contained in the base file, in accordance with a set of instructions. The test file may be saved as part of a test file suite assembled from a number of test files generated by the file generating system. The test file may then be used to test the ability of an EDI system to receive, process or transmit an EDI data file containing the modified data field.

### DESCRIPTION OF THE DRAWINGS

FIG. 1 is a box diagram illustrating one possible embodiment of a test file generating computer system in accordance with one aspect of the present invention;

FIG. 2 is a flowchart depicting one possible embodiment of a process for generating EDI testing data files, in accordance with one aspect of the present invention; and

FIG. 3 is a flowchart depicting one possible embodiment of a process for testing the receiving of EDI data files by generating test files and examining the reception and processing capability of a system for those test files, in accordance with one aspect of the present invention.

### DETAILED DESCRIPTION OF THE INVENTION

The present invention provides methods and systems for generating test data files for examining EDI processing, transmission, and reception capabilities. In one embodiment, the present invention makes use of a testing file generating computer system accessible over a network and a test file generating database stored in a memory thereon to carry out the methods described herein.

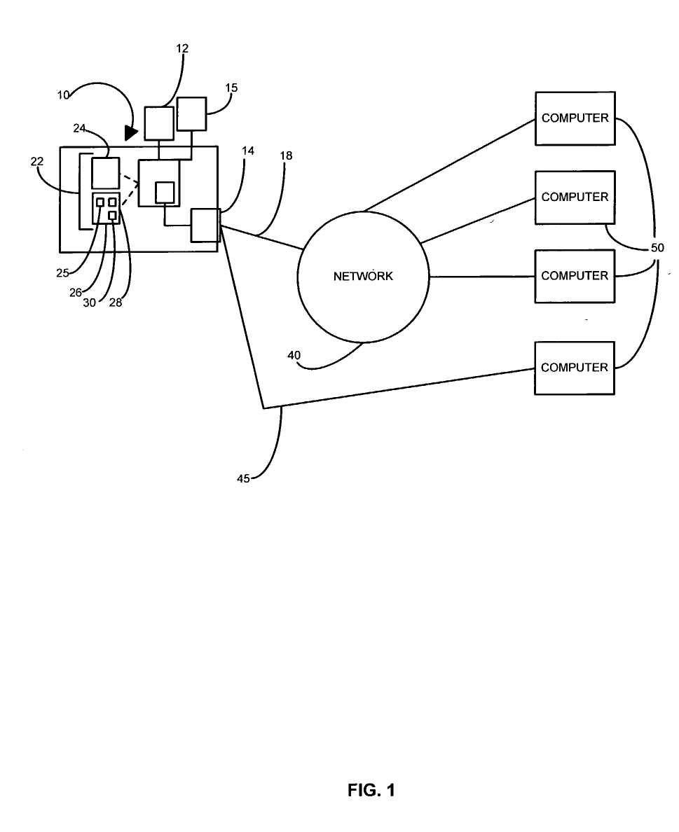

Referring to drawing FIG. 1, one possible embodiment of a system for generating testing files for EDI transactions is depicted, including test file generating computer system 10 for carrying out the methods and processes of the present invention. It will be appreciated that although test file generating computer system 10 is depicted as a single computer for simplicity, that any number of different computers functioning to act as a single system for carrying out the processes or methods described herein may be used and is within the scope of the present invention. Test file generating computer system 10 may include or function as a Web interfacing system (e.g., a Web server) for enabling access and interaction with other devices linked to local and external communication networks (“networks”), including the World Wide Web (the “Internet”), a local area network (LAN), a wide area network (WAN), an intranet, the computer network of an online service, etc. Test file generating computer system 10 optionally may include one or more local displays 15, which may comprise a conventional monitor, a monitor coupled with an integrated display, an integrated display (e.g., an LCD display), or other means for viewing data or processing information. One or more interface modules may also be present to support input and output between a user and the test file generating computer system 10 through an interface device 12 such as a joystick, keyboard, mouse or data glove. Test file generating computer system 10 may also include a network interface (I/O) 14 for bidirectional data communication through one or more and preferably all of the various networks (LAN, WAN, Internet, etc.) using communication paths or links known in the art, including wireless connections, ethernet, bus line, Fibre Channel, ATM, standard serial connections, and the like.

Still referring to drawing FIG. 1, test file generating computer system 10 includes one or more microprocessors 20 responsible for controlling all aspects of the computer system. Thus, microprocessor 20 may be configured to process executable programs and/or communications protocols which are stored in memory 22. Microprocessor 20 is provided with memory 22 in the form of RAM 24 and/or hard disk memory 26 and/or ROM (not shown). As used herein, memory designated for temporarily or permanently storing one or more testing file generating protocols on hard disk memory 26 or another data storage device in communication with test file generating computer system 10 is referred to as “testing file generating database” 25. Similarly, memory designated for temporarily or permanently storing one or more test files generated by the test file generating computer system 10 on hard disk memory 26 or another data storage device in communication with test file generating computer system 10 is referred to as “test file database” 30 and memory designated for temporarily or permanently storing base files submitted to the test file generating computer system 10 on hard disk memory 26 or another data storage device in communication with test file generating computer system 10 is referred to as “base file database” 28.

In one embodiment of the present invention, test file generating computer system 10 uses microprocessor 20 and the memory stored protocols to exchange data with other devices/users on one or more of the networks via Hyper Text Transfer Protocol (HTTP) and Simple Mail Transfer Protocol (SMTP), although other protocols such as File Transfer Protocol (FTP), Simple Network Management Protocol (SNMP), and Gopher document protocol may also be supported. Web page like interfaces with the remote computers 50 may thus be used. Test file generating computer system 10 may further be configured to send and receive HTML formatted files. In addition to being linked to a local area network (LAN) or wide area network (WAN), test file generating computer system 10 may be linked directly to the Internet via network interface 14 and communication links 18 attached thereto, or be capable of linking directly to a remote computer 50 (as will be discussed further herein).

Test file generating computer system 10 will preferably contain executable software programs stored on hard disk 26 related to the operation of a Web server. Hard disk 26 may also contain specific software programs relating to the operation of generating EDI files, as in test file generation database 25. Alternatively, a separate hard disk, or other storage device, (not shown) may optionally be provided with the requisite software programs for conducting the testing methods as described herein.

Test file generating computer system 10 is able to communicate with remote computers 50. This may be accomplished in any suitable fashion. For example, communication may occur over a network 40, which may include the internet, to which test file generating computer system 10 is in operative communication via network interface 14 and communications link 18. Alternatively, test file generating computer system 10 may be directly communicate with a remote computer 50, using a direct connection 45 in operative connection with communications link 14, such as a direct dial connection over telephone lines, or another suitable connection.

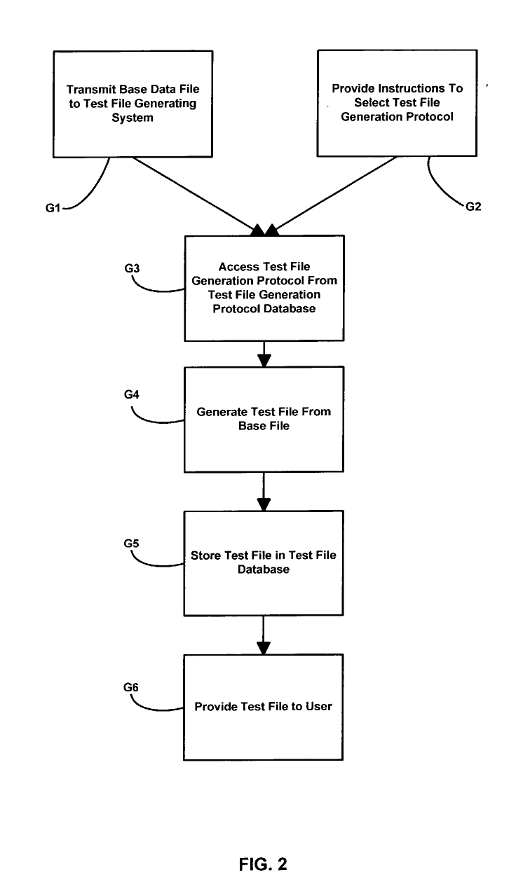

Turning to drawing FIG. 2, one embodiment of a process in accordance with the present invention for generating test data files depicted. For the purposes of understanding, this process will be detailed in connection with the system depicted in drawing FIG. 1. It will, of course, be appreciated that the flowchart is illustrative only and while it depicts only one possible embodiment of a process, that other processes in accordance with the teachings of the present invention are possible, and that any suitable computer system may be used, and all such variations are within the scope of the present invention.

Typically, to initiate the process, a communicative connection is made between a remote computer 50 and the test file generating computer system 10. This may be accomplished through communicating over the network (which may include the internet), as by supplying web pages to the remoter computer 50 from the test file generating computer system 10 in response to a user request, by using a modem or other communication device attached to a remote computer 50 to “dial in” or otherwise connect to the test file generating computer system 10, or as is otherwise known to those of ordinary skill in the art.

Once a connection is established, a base data file is transmitted to the test file generating computer system 10, as depicted in box G1. Typically this occurs through a user submission. The transmission may be accomplished in any suitable manner, such as by submitting the file through a web page interface transmitted to the remote computer 50, either over the network 40 or a direct connection 45 by the test file generating computer system 10, by transmitting the file as an email, or any other suitable method. As discussed previously herein, an X12 compliant EDI data file may be represented as a string of segments, each segments including or other data elements. Each segment may thus be thought of as containing one or more data fields, each data field containing a piece of information for the EDI transaction.

The base file may be a single data file, such as an X12 compliant EDI transmission file, from which one or more test data files can be generated. For example, if the user of a remote computer 50 is a supplier who receives orders for goods from merchants the base file may be a representative transmission of an order placement. Similarly, if the remote computer 50 belongs to a healthcare insurer, or other third party payor, the base data file may be a representative transmission of a claim for payment of benefits. Mock information can be used in the base file, rather than actual client or patient information. This enables processes and systems in accordance with the present invention to be used to generate test data files from a single base file that is user created without potentially confidential information. Alternatively, the base file may be an actual EDI transaction file that is selected by the submitter and contains actual trading partner information (“TPI”), such as unique trading partner identifying information. Such a base file may be used to create test data files that identify a unique preexisting (or potential) trading partner for examining the treatment and/or processing of EDI files identified with that trading partner, or where such TPI may be required for the acceptance or processing of such files (for example, in order to issue a certification to a specific potential trading partner a user may require that certain tests be passed with EDI files that identify that potential trading partner). It will be appreciated that where appropriate, a “mock” trading partner identified by a specific set of TPI associated with a non-actual trading partner maybe created for testing purposes only, and a base file containing the TPI for the mock trading partner may be used.

Instructions are then provided to the test file generating computer system 10 to follow a protocol to generate one or more test files, as depicted in box G2. A default set of instructions may be provided by the transmission of a base file, a set of user associated instructions may be automatically accessed based on a unique identifier associated with a user, or a user may expressly provide instructions. User provided instructions may be submitted prior to, contemporaneously with, or after the transmission of the base file. The user provided instructions may select a specific test file generation protocol for generating a test files with specific attributes. For example, instructions maybe submitted to select a protocol that generates a suite of test files for testing the ability of a remote computer system 50 to receive or process specific types of EDI files, such as EDI files containing claims for payments of benefits, or EDI files compliant with an X12 Implementation Guideline for specific type of healthcare user.

It will be appreciated that the test file protocol used maybe structured to create test files for examining any desired aspect of an EDI receiving or processing system. For example, with EDI test files that are X12 compliant, protocols may be designed that generate test files for examining parameters of a system, for example: the generation of test data files that use valid and/or invalid ranges for various elements that are required by the X12 or specific usage (such as HIPAA compliance) protocols; the generation of test data files that repeat segments, data loops or data fields of the base file to examine the effect of required or permissive repeat count handling; the generation of test data files that include nonsensical or improbable data in the test file, which may even be syntactically correct (such as invalid dates or times, i.e. Feb. 31, 2003 or 25:30 PM); through the generation of test files that lack required or optional data elements, or containing non-matching data elements (such as elements that may not appear together or non-matching code numbers in a single loop); through the generation of test data files that contain malformed data or the malformation of required data formats; through the generation of test data files where segments are misordered, or where segments comprise random text or random binary data; through the generation of test data files with number formatting problems, such as the replacement of decimal values with exponential values; through the generation of test data files with missing, incorrect or non-matching control numbers in one or more data tags; through the generation of test data files that use X12 compliant data codes that are non-compliant for the specific usage (such as HIPAA compliance) protocols; or any other desired file format or data change that may be used to test the capability of a system to receive, send or process an EDI file. Suitable protocols may create a number of test data files, each with a single modification, or to create a single test data file with any number of desired modifications (or a number of such test data files), as is desired for the parameters or systems to be tested.

A test file generation protocol is then accessed from the test file generation database 25, as depicted in box G3. The accessed test file generation protocol may be used to generate one or more test files by taking the base file and creating a copy thereof while varying data, formatting, or other characteristics to generate each test file, as discussed previously herein. For example, a medical EDI file containing billing information for the treatment of a patient may need to include an explanation of services rendered to the patient. This explanation may occupy one or more data fields in the EDI file. In order for a receiving system to successfully receive and process actual EDI messages, it may need to accept varying numbers of characters in these data fields. The test file generation protocol may vary data in these fields to arrive at any number of different variations within this range. Generated test files may then be used to test this aspect of a receiving system. It will be appreciated that a certain protocol may thus be designed to generate a specific type of testing file designed to test one aspect of a receiving system, or to generate a set of testing files designed to test one or more aspects that are required to certify a specific type of EDI receiving system.

A test file is then generated from the base file using the selected protocol, as described in box G4. This may be accomplished by the microprocessor 20 executing a set of instructions representing the selected test file generating protocol. The resulting test file may be stored in memory 22, in test file database 30, as described in box G5. Where the selected test file generating protocol generates multiple test files from a single base file, all resulting test files maybe stored in the test file database 30. A number of such related files may be assembled into a test file suite that is stored in the test file database 30. Each test file suite may contain any number of test files, from a single test file for examining a specific receiving or processing ability to thousands of test files for certifying a receiving systems ability to participate as a trading partner in an ongoing EDI relationship. One or more files stored in the test file database 30 may be associated with the base file stored in a base file database 28. This association may allow a user accessing the test file generating computer system 10 to obtain test files generated from a previously submitted base file at a subsequent time.

Test files may then be provided to a user as described in box G6. This provision may occur in a number of different ways. For example, the test files may be conveyed to a user over a network 40, or a direct connection 45, directly to a remote computer 50, using network interface 14 and associated hardware and software. This provision may be provided as an email transmission, through accessing a web page-like interface over the connection using HTTP or another suitable protocol. A user at a remote computer 50 could enter a command into a web page-like, or other interface, and access the test files during the same or a subsequent connection to the test file generating computer system 10. Test files may even be stored on memory 22 that is a removable memory media, such as a floppy disk, flash card, CD-ROM disc, zip disk, or otherwise as is known in the art. The removable media may then be delivered to a user to provide the test files. Any other suitable means for providing a user with the generated test files known now, or in the future, to those of ordinary skill in the art may be used and is within the scope of the present invention.

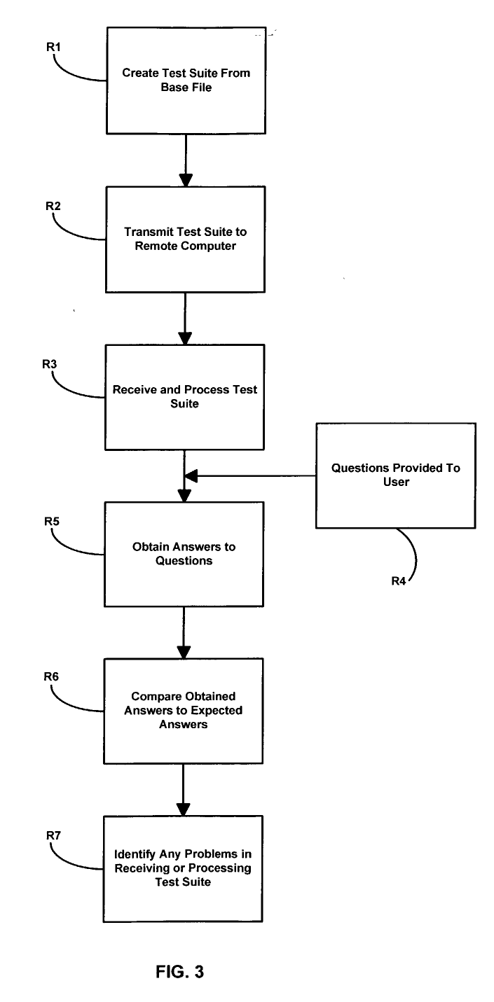

Turning to drawing FIG. 3, a flowchart depicting a process for examining a system's ability to receive and process data files is depicted. As shown in box R1, a test suite of data files are created from a base file provided by a remote computer 50. The test suite may consist of one or more test data files, preferably a number of test data files, and may be created from one or more base files using a test file generation protocol, as discussed in connection with drawing FIG. 2.

The test suite is then transmitted to a remote computer system 50 for receiving and processing, as described in box R2. The test suite will typically be transmitted as a number of data packets conveyed from the test file generating computer system 10 to the remote computer system 50 over network 40 or direct connection 45, in order to fully mimic the reception of files from a sending trading partner. This may occur in response to a request submitted via a web page or other interface. It will be appreciated however, that it is within the scope of the present invention to provide the files in any suitable manner, such as on a computer readable storage medium (CD-rom, floppy disk, zip disk, etc.), if desired.

Once provided, the test suite is received and processed by the receiving remote computer system 50, as depicted in box R3. it will be appreciated that processing of an EDI data file may include the directing, or routing, of received EDI files from a “front-end” receiving system (or receiving portion of a computer system 50) to a “back end” processing system (or portion of the same system 50), as by routing a claim for payment contained in an EDI file to the appropriate system or personnel (as by email or other appropriate protocol) for examination or preparation of payment.

A number of questions may also be provided to the receiving remote computer system 50, as shown in box R4. The questions may be provided with the test suite, or may be separately provided at a different time. As the test suite is processed, answers to the questions are obtained, as depicted in box R5. This may be accomplished by generating an answer file containing certain collected information during the processing of the test data files, by providing a user with a list of questions and requiring the user to obtain answers to the questions following reception and processing by the remote computer 50, or otherwise as is known to those of ordinary skill in the art.

The answers are then compared to a set of expected answers for that test suite, as shown in box R6. The set of expected answers for that test suite may be developed by the test file generating computer system 10, executing a set of instructions retained in memory 22 to create expected answers for the test suite. The expected answers may be generated as the test suite is created, or at any subsequent time. The comparison of the obtained answers to the expected answers may be performed by a user of the remote computer 50, by the remote computer 50, or by the test file generating system 10. Where the comparison is performed by the test file generating system 10, the obtained answers may be conveyed to the test file generating system 10 using any suitable protocol, such as HTTP or email, or by conveying the information on removable memory media.

By comparing differences between the provided answers and the expected answers, problems in the receipt and processing of transmitted files may be identified. Where problems in receiving or processing the test suite are found, identification allows changes to be made and the process to be repeated, as shown in box R7.

It will be appreciated that a number of varying testing suites may be provided by utilizing different test file generating protocols, enabling a receiving remote computer 50 to be examined for a number of different aspects of receiving and processing abilities. Further, specific tailoring of testing suites by the testing suite generating protocols can allow a third party tester providing the test file generation system 10 to test and certify systems for receiving transmissions from different types of senders. For example, using the HIPAA model, different test file generation protocols may be used to generate test file suites allowing a single receiving remote computer 50 to be separately tested for receiving claims from physician's offices and for receiving hospital claims. These protocols may even function from the same base data file. Protocols may even be designed to produce test data file that include deliberately defective files to determine the ability of the receiving remote computer 50 to detect and reject such files.

It will be appreciated by those skilled in the art that the embodiments of the present invention herein described are not intended to limit the invention and that various combinations and modifications of the embodiments of the present invention could be made without departing from the scope thereof and that all such modifications are within the scope of the present invention. For example, it is understood that while the methods and apparatus of the present invention have been described in relation to a remote computer system interacting with a test file generating computer system using web page like interfaces, one of skill in the art will recognize that the present invention maybe utilized with a wide variety of interfaces and communication protocols. Similarly, while the methods, processes and apparatus of the present invention have been described in terms of X12 format EDI files, alternative format EDI files, other types of data transmission or reception files, or even program like files could be utilized as base files for the generation of test files and all such variations are within the scope of the present invention.

Thus, while certain representative embodiments and details have been shown for purposes of illustrating the invention, it will be apparent to those skilled in the art that various changes in the invention disclosed herein may be made without departing from the scope of the invention, which is defined in the appended claims.

What is claimed is:

1. A process of creating test data files, said process comprising:
receiving a data transmission file comprising at least one data field containing data content at a test file generator; and
creating at least one data transmission test file by varying the data content in said at least one data field.

2. The process according to claim 1, wherein creating at least one data transmission test file by varying the data content in said at least one data field comprises altering the amount of said data content.

3. The process according to claim 2, wherein altering the amount of said data content comprises lengthening or shortening a character string contained in said at least one data field.

4. The process according to claim 1, wherein creating a data transmission test file by varying the data content comprises varying the data content in accordance with a test file generating protocol.

5. The process according to claim 4, wherein varying the data content in accordance with a test file generating protocol comprises repeating segments or data loops in said at least one data field of an X12 compliant data transmission file.

6. The process according to claim 4, wherein varying the data content in accordance with a test file generating protocol comprises inserting nonsensical data in said at least one data field.

7. The process according to claim 4, wherein varying the data content in accordance with a test file generating protocol comprises omitting data from said at least one data field.

8. The process according to claim 4, wherein varying the data content in accordance with a test file generating protocol comprises inserting non-matching data elements in said at least one data field.

9. The process according to claim 1, wherein receiving a data transmission file comprising at east one data field containing data content comprises receiving an EDI data file.

10. The process according to claim 9, wherein receiving an EDI data file comprises receiving an X12 compliant EDI data file.

11. The process according to claim 1, wherein receiving a data transmission file comprising at least one data field comprises receiving a data transmission conveyed over a network connection.

12. The process according to claim 11, wherein receiving a data transmission conveyed over a network connection comprises receiving a data transmission conveyed over the internet.

13. The process according to claim 11, wherein receiving a data transmission conveyed over a network connection comprises receiving a transmission conveyed using a transfer protocol selected from the group consisting of HTTP, SMTP, FTP, SNMP, and Gopher document protocol.

14. The process according to claim 1, further comprising creating at least a second data transmission test file by varying the data content in said at least one data field.

15. The process according to claim 14, further comprising assembling said at least one data transmission test file and said at least second data transmission test file into at least one test suite.

16. The process according to claim 1, further comprising conveying said at least one data test file to a testing user.

17. A system for generating test data files, said system comprising:
a test file generating computer system configured to receive one or more data file transmissions containing content comprising at least a first information set in at least a first data field from a sending system in communication therewith, said test file generating computer system configured to create test data files by generating a copy of a received data file transmission with an alteration in said first information set from said at least a first data field.

18. The system of claim 17, wherein said test file generating computer system is in communication with said sending system over a network.

19. The system of claim 17, wherein said network comprises the Internet.

20. The system of claim 17, wherein said test file generating computer system is in communication with said sending system via a direct connection.

21. The system of claim 17, wherein said test file generating computer system is configured to receive one or more data file transmissions using a transfer protocol selected from the group consisting of HTTP, SMTP, FTP, SNMP, and Gopher document protocol

22. The system of claim 17, wherein said test file generating computer system is configured to create test data files by generating a copy of a received data file transmission with an alteration in said first information set from said at least a first data field by generating a copy of a received data file transmission with a change in the amount of data contained in said first information set.

23. The system of claim 22, wherein said test file generating computer system is configured to create test data files by generating a copy of a received data file transmission with a change in the amount of data contained in said first information set by altering the length of a character string contained in said first data set.

24. The system of claim 17, wherein said test file generating computer system is configured to create test data files by generating a copy of a received data file transmission with an alteration in said first information set by altering said first information set in accordance with a test file generating protocol stored in a memory accessible by said test file generating computer system.

25. The system of claim 24, wherein said test file generating computer system is configured to access said test file generating protocol from said memory in accordance with a set of user provided instructions.

26. The system of claim 24, wherein said test file generating computer system is configured to access said test file generating protocol by one of a set of test file generating protocols stored in said memory accessible by sad test file generating computer system.

27. The system of claim 17, wherein said test file generating computer system is further configured to assemble created test data files into test file suites.

28. The system of claim 27, wherein said test file generating computer system is configured to assemble created test data files into test file suites containing test data files for examining the ability of a computer system to receive or process data transmissions meeting certain required parameters.

29. The system of claim 17, wherein said test file generating computer system is configured to receive one or more data file transmissions containing content comprising at least a first information set in at least a first data field from a sending system in communication therewith by being configured to receive EDI data file transmissions.

30. The system of claim 29, wherein said test file generating computer system is configured to receive EDI transmissions by being configured to receive X12 compliant EDI data transmissions.

31. The system of claim 17, wherein said test file generating computer system is further configured to convey created test data files to said sending system in communication therewith.

32. The system of claim 18, wherein said test file generating computer system is configured to receive one or more data file transmissions containing content comprising said at least a first information set in said at least a first data field and at least a second information set in at least a second data field from a sending system in communication therewith, said test file generating computer system configured to create test data files by generating a copy of a received data file transmission with an alteration in said at least first information set from said at least a first data field and an alteration in said at least second information set from said at least a second data field.

33. An apparatus for generating test data files, said apparatus comprising:
receiving apparatus for receiving one or more data file transmissions containing content comprising at least a first information set in at least a first data field; and
generating apparatus for generating test data files by creating a copy of a received data file transmission with an alteration in said first information set from said at least a first data field.

34. The apparatus of claim 33, wherein said generating apparatus for generating test data files by creating a copy of a received data file transmission with an alteration in said first information set from said at least a first data field is configured to create a data test file by generating a copy of a received data file transmission with a change in the amount of data contained in said first information set.

35. The apparatus of claim 33, wherein said receiving apparatus for receiving one or more data file transmissions containing content comprising at least a first information set in at least a first data field is configured for receiving one or more data file transmissions containing content comprising at least a second information set in at least a second data field; and said generating apparatus for generating test data files is configured for creating a copy of a received data file transmission with an alteration in said second information set from said at least second data field.

36. The apparatus of claim 34, wherein said generating apparatus for generating test data files is configured to create test data files by generating a copy of a received data file transmission with a change in the amount of data contained in said first information set by altering the length of a character string contained in said first data set.

37. The apparatus of claims 33, further comprising an accessing apparatus for accessing a test file generation protocol stored in a memory in communication with said generating apparatus for generating test data files.

38. The apparatus of claim 37, wherein said generating apparatus for generating test data files is configured to create test data files by generating a copy of a received data file transmission with an alteration in said first information set by altering said first information set in accordance with a test file generating protocol accessed from a memory in communication with sad means for generating test data files with said accessing apparatus for accessing a test file generation protocol.

39. The apparatus of claim 38, wherein said accessing apparatus for accessing a test file generation protocol is configured to access said test file generating protocol from said memory in accordance with a set of user provided instructions.

40. The apparatus of claim 33, wherein said receiving apparatus for receiving one or more data file transmissions is configured to receive said one or more data file transmissions over a network.

41. The apparatus of claim 40, wherein said network comprises the Internet.

42. The apparatus of claim 33, wherein said receiving apparatus for receiving one or more data file transmissions is configured to receive said one or more data file transmissions via a direct connection.

43. The apparatus of claim 33, wherein said receiving apparatus for receiving one or more data file transmissions is configured to receive one or more data file transmissions using a transfer protocol selected from the group comprising: HTTP, SMTP, FTP, SNMP, and Gopher document protocol.

44. The apparatus of claim 33, wherein said receiving apparatus for receiving one or more data file transmissions is configured to receive EDI data file transmissions.

45. The apparatus of claim 44, wherein said receiving apparatus for receiving one or more data file transmissions is configured to receive X12 compliant EDI data transmissions.

46. The apparatus of claim 33, further comprising an assembling apparatus for assembling created test data files into test file suites.

47. The apparatus of claim 46, wherein said assembling apparatus for assembling created test data files into test file suites is configured to assemble test data file suites containing test data files for examining the ability of a computer system to receive or process data transmissions meeting certain required parameters.

48. The apparatus of claim 33, further comprising a conveying apparatus for conveying created test data files to a remote computer.

49. A method of examining the ability of a computer system to receive EDI transmissions, said method comprising:
receiving a base EDI data file at a receiving test file generating computer;
generating at least one test EDI data file by varying data content in the base EDI data file;
conveying said at least one test EDI data file to a remote computer system for processing by the remote computer system;
comparing an outcome of said processing by the remote computer system to an expected outcome for said at least one EDI test data file.

50. The method according to claim 49, wherein generating at least one test EDI data file by varying data content in the base EDI data file comprises altering the amount of data content in at least one data field of said base EDI data file.

51. The method according to claim 50, wherein altering the amount of said data content comprises lengthening or shortening a character string contained in said at least one data field.

52. The method according to claim 49, wherein receiving a base EDI data file at a receiving test file generating computer comprises receiving an X12 compliant EDI data file.

53. The method according to claim 49, wherein receiving a base EDI data file at a receiving test file generating computer comprises receiving a data transmission conveyed over a network connection.

54. The method according to claim 53, wherein receiving a data transmission conveyed over a network connection comprises receiving a data transmission conveyed over the internet.

55. The method according to claim 53, wherein receiving a data transmission conveyed over a network connection comprises receiving a data transmission conveyed using a transfer protocol selected from the group comprising: HTTP, SMTP, FTP, SNMP, and Gopher document protocol.

56. The method according to claim 49, wherein generating at least one test EDI data file by varying data content in the base EDI data file comprises repeating segments or data loops of said base EDI data file.

57. The method according to claim 49, wherein generating at least one test EDI data file by varying data content in the base EDI data file comprises inserting nonsensical data in said base EDI data file.

58. The method according to claim 49, wherein generating at least one test EDI data file by varying data content in the base EDI data file comprises omitting data from said base EDI data file.

59. The method according to claim 49, wherein generating at least one test EDI data file by varying data content in the base EDI data file comprises inserting non-matching data elements in said base EDI data file.

60. The method according to claim 49, wherein generating at least one test EDI data file by varying data content in the base EDI data file comprises misordering segments of said base EDI data file.

61. The method according to claim 49, wherein generating at least one test EDI data file by varying data content in the base EDI data file comprises replacing decimal format values in said base EDI data file with exponential format values.

62. The method according to claim 49, further comprising generating at least a second test EDI data file by varying data content in the base EDI data file to create a testing EDI data file differing from said base EDI data file and from said at least a one test EDI data file.

63. The method according to claim 62, further comprising assembling said at least one EDI test data test file and said at least a second EDI test data test file into at least one test suite.

64. The method according to claim 63, wherein conveying said at least one data file to a remote computer system for processing by the remote computer system comprising conveying said at least one test suite.

65. The method according to claim 49, wherein comparing an outcome of said processing by the remote computer system to an expected outcome for said at least one EDI test data file comprises conveying said outcome of said processing by the remote computer to a third party tester that conducts said comparison and issues a result.

66. The method according to claim 49, wherein comparing an outcome of said processing by the remote computer system to an expected outcome for said at least one EDI test data file comprises comparing an answer to a provided question concerning said processing to an expected answer.
